(19) United States
(12) Patent Application Publication
(10) Pub. No.: US 2016/0205396 A1
(43) Pub. Date: Jul. 14, 2016

(54) METHOD FOR ERROR DETECTION FOR AT LEAST ONE IMAGE PROCESSING SYSTEM

(71) Applicant: FTS COMPUTERTECHNIK GMBH, Wien (AT)

(72) Inventors: Stefan Traxler, Wien (AT); Eric Schmidt, Großkrut (AT)

(21) Appl. No.: 14/912,954

(22) PCT Filed: Aug. 13, 2014
(86) PCT No.: PCT/AT2014/050175

§ 371 Date: Feb. 19, 2016

(30) Foreign Application Priority Data
Aug. 20, 2013 (AT) A50516/2013
Oct. 14, 2013 (AT) A50660/2013

(51) Int. Cl. H04N 17/00; G06K 9/03; G06K 9/62; G06K 9/00

(52) U.S. Cl. CPC H04N 17/002; G06K 9/00791; G06K 9/03; G06K 9/6202

(57) ABSTRACT

A method for error detection for at least one image processing system for capturing the surroundings of a motor vehicle, comprising the following steps: a) capturing at least one first primary image (PB1), b) producing at least one first reference image (RB1) by introducing at least one reference feature (RM) into the at least one first primary image (PB1), c) processing the at least one first reference image (RB1) with the aid of at least one algorithm to be checked, d) extracting at least one test feature (TM) associated with the at least one reference feature (RM) from the processed at least one first reference image (RB1), e) comparing the at least one test feature (TM) with the at least one reference feature (RM) and using the result of the comparison in order to determine the presence of at least one error.

The invention relates to a method for error detection for least one image processing system, in particular for capturing the surroundings of a vehicle, particularly preferably a motor vehicle.

The invention also relates to an error detection device for at least one image processing system or an algorithm implemented therein which is to be checked, in particular for capturing the surroundings of a vehicle, particularly preferably a motor vehicle.

Optical/visual measuring or monitoring devices for detecting object movements are already known from the prior art. Depending on the application of these measuring or monitoring devices, different requirements are placed on the accuracy and reliability of the measuring or monitoring devices. For error detection of incorrect measurement and/or calculation results, redundant measuring or monitoring devices and/or calculation algorithms are often provided, with the aid of which the measurement and/or calculation results can be verified or falsified.

A visual monitoring device of this type is disclosed for example in

DE 10 2007 025 373 B3 and can record image data comprising first distance information and can identify and track objects from the image data. This first distance information is checked for plausibility on the basis of second distance information, wherein the second distance information is obtained from a change of an image size of the objects over successive sets of the image data. Here, only the obtained distance information is used as a criterion for checking the plausibility. Errors in the image detection or image processing that do not influence this distance information therefore cannot be detected.

The object of the invention is therefore to create a error detection for at least one image processing system, which detection is performed reliably, using little processing power, and also independently or redundantly where possible, and can be implemented economically and is configured to identify a multiplicity of error types.

In a first aspect of the invention this object is achieved with a method of the type mentioned in the introduction, in which, in accordance with the invention, the following steps are provided:

a) capturing at least one first primary image,

b) producing at least one first reference image by introducing at least one reference feature into the at least one first primary image,

c) processing the at least one first reference image with the aid of at least one algorithm to be checked,

d) extracting at least one test feature associated with the at least one reference feature from the processed at least one first reference image,

e) comparing the at least one test feature with the at least one reference feature and using the result of the comparison in order to determine the presence of at least one error.

Thanks to the method according to the invention, it is possible to reliably identify a multiplicity of errors using little processing power. Errors which are produced during the processing of the reference images and which influence the test features can thus be reliably detected. By way of example, cars or robots can be considered as motor vehicles, in particular moving robots, aircraft, waterborne vessels or any other motorised technical systems for movement.

Since the properties of the reference feature can be predefined and the behaviour of the algorithm processing the first reference image can be adequately predicted, expected values in respect of the test feature can be generated. Depending on the image-processing algorithm, values can be predicted for the anticipated correlation between the test feature and the reference feature. A value deviating significantly from the anticipated correlation may thus be used in step g) in order to identify errors in the processing of the images. A further advantage of the invention lies in the fact that no further images are required, and instead of the reference image can be produced independently, without the addition of external information. The invention relates in particular to the capture of the surroundings of a vehicle, but is also suitable for other applications.

Here, it may in particular be advantageous if the at least one reference feature is characterised by a local colour and/or contrast and/or image sharpness manipulation and/or by a local arrangement of pixels.

It is advantageous here if, before step b), the at least one first primary image is checked for the presence of relevant image features, and in step b) the at least one reference feature is inserted into at least one region of the at least one first primary image, in which region there are no relevant image features present.

In order to be able to additionally increase the accuracy of the error detection, in step b) at least two, preferably more reference features can be introduced into the at least one first primary image, wherein in step d) a test feature is extracted for each reference feature.

In a favourable variant of the method according to the invention, in step a) at least one second primary image is captured, wherein in step b) at least one second reference image is produced with the aid of the second primary image, wherein in step c) the at least one test feature is extracted from the at least two reference images. The two primary images may be captured for example at the same time by means of two sensors, whereby depth information can be obtained very quickly by comparison of the two primary images. The test feature may contain depth information in the same manner.

In accordance with a development of the method according to the invention, the at least one reference feature and/or the at least one test feature may relate to at least one object, wherein location information relating to the at least one reference feature and/or the at least one test feature is extracted. Simple objects, such as triangles, squares or polygons can be used as reference feature/test feature. The selection of the reference features is substantially dependent on the detection algorithms. For conventional “corner detectors”, single-coloured, for example white squares would be suitable for example, which accordingly would produce 4 corners. In order to remove these from the rest of the image, these squares could be surrounded by a dark zone, which becomes increasingly translucent outwardly (i.e. transitions continuously into the original image). In a favourable embodiment of the method according to the invention the at least one first primary image is recorded with the aid of at least one first sensor.

In a further advantageous embodiment of the method according to the invention at least the first and the second primary image can be recorded with the aid of the first sensor, wherein the second primary image is recorded once the first primary image has been recorded. The use of a single sensor provides the advantage that this variant can be performed economically and at the same time in a robust manner. Information concerning the movement and spatial position of the individual features can be obtained from a chronological series of relevant features belonging to the primary images (and/or secondary images). This technique is known by the term “Structure from Motion” and can be used advantageously in conjunction with the invention.

Alternatively, at least the first primary image can be recorded with the aid of the first sensor and at least the second primary image can be recorded with the aid of a second sensor. It is thus possible simultaneously to record images from different perspectives by means of the two sensors and to generate depth information by means of a comparison of the images. A simultaneous recording from different perspectives provides the advantage of making the depth information accessible particularly quickly, since there is no need to wait for a chronological series of the images. In addition, a relative movement of the surroundings in relation to the sensors is not necessary. This technology is known by the term “Stereo 3D” and can be used advantageously in conjunction with the invention.

An additional possibility for detecting errors is provided in a further-developed embodiment of the method according to the invention, in which in step a) the at least one first primary image is captured on the basis of a primary image source,
wherein, in a step f) that can be carried out after step a), at least one first secondary image is produced or captured by displacing and/or rotating the at least one first primary image and/or the at least one first reference image,
wherein, in a step g) that can be carried out after step f), the at least one first secondary image is processed with the aid of the algorithm to be checked, and
in a step h) that can be carried out after step g) the at least one first processed primary image and/or the at least one first processed reference image is compared with the at least one first processed secondary image, and the results of the comparison is used additionally to determine the presence of at least one error.

The order of steps can otherwise be arbitrarily selected. Step f) can therefore occur after step b), c), d) or also e). Merely step h) requires the completion of at least step c).

The term “primary image source” is understood within the scope of this application to mean an image region (actually recorded or also partly fictitious) from which the at least one first primary image was removed and which is at least the same size as, but generally larger than, the image region of the at least one first primary image. The at least one first secondary image in step f) on the one hand can be produced virtually, and on the other hand it is also possible to use an image captured at a subsequent moment in time as secondary image. The displacement and/or the rotation can be performed by natural relative movement between the at least one first primary image and an image region located at least partially within the primary image source and captured at a subsequent moment in time (in the form of a secondary image). Such a relative movement may be present for example in a simple manner when a camera mounted on a vehicle is configured to capture the primary and secondary images. Movements of the vehicle relative to the surroundings captured by the camera can thus be used to produce a “natural” displacement/rotation of the at least one first secondary image. This also has the advantage that the secondary images can be utilised in a next step as primary images for the next check and can be used directly, and the processing of the images only has to be performed once in each case.

In accordance with a development of the method according to the invention, after step a) at least one primary image the church can be extracted from the at least one first primary image and/or from the at least one first reference image, and
after step f) at least one secondary image feature can be extracted from the at least one first secondary image, and
in step h) the at least one primary image feature can be compared with the at least one secondary image feature.

The comparison of the at least one primary image feature with the at least one secondary image feature and the use of the result of the comparison to determine the presence of at least one error can be implemented for example by checking the correlation between the primary image feature and the secondary image feature or the underlying displacement and/or rotation. Alternatively, any degree of similarity between the primary image feature and the secondary image feature can be used in essence. If the displacement and/or the rotation of a secondary image is known for example, the Euclidean distance between points of a secondary image feature and points that can be derived from the primary image features can thus be placed in relation to the displacement and/or rotation of the secondary image and can be used to form a threshold value in order to assess the presence of an error in step e).

In an advantageous embodiment of the method according to the invention the at least one primary image feature can be calculated by local colour information and/or a local contrast and/or a local image sharpness and/or local gradients in at least the first primary image, and/or the at least one secondary image feature can be calculated by local colour information and/or a local contrast and/or a local image sharpness and/or local gradients in at least the first secondary image. This allows a quick and reliable detection of relevant image features. Object boundaries or object edges or corners constitute examples of such relevant primary image and/or secondary image features.

In accordance with a development of the method according to the invention, at least one second primary image can be captured in step a) and used for extraction of the at least one primary image feature, wherein in step f) at least the first and the second primary image are displaced and/or rotated and at least the first secondary image and/or an additional second secondary image is produced under consideration of the second primary image, and after step f) the at least one secondary image feature is extracted from the first secondary image and/or the second secondary image. By using a second primary image, primary image features/secondary image features comprising depth information can be obtained for example, by combining the two primary images and/or the two secondary images.

In order to enable a particularly efficient error detection, it may be advantageous if the at least one primary image feature and/or the at least one secondary image feature relates to at least one object, wherein location information is extracted for the at least one primary image feature and/or the at least one secondary image feature.

In accordance with an advantageous development of the invention the at least one first primary image is rotated in step f) about a vertical axis located in the centre of the image. The rotation about this axis causes the pixels to remain within the image region and to move closer to one another. This change can be particularly easily detected and reversed.

Alternatively, the rotation could occur for example about an individual pixel, wherein the axis preferably can be positioned such that the sum of the distances from the pixel contained in the image is minimised.

In a development of the method according to the invention, the displacement and/or rotation of the at least one first primary image in step f) may be achieved at least by a physical displacement and/or rotation of the position and/or the orientation of the at least one first sensor.

Alternatively, the displacement and/or rotation of the at least one first primary image in step f) can be achieved at least by a digital processing of the primary image. Here as well, a relative movement between the vehicle and the vehicle surroundings does not have to be provided, for example.

In a second aspect of the invention the above-stated object is achieved with an error detection device of the type mentioned in the introduction, wherein at least one computing unit is configured to
capture at least one first primary image on the basis of a primary image source,
produce at least one first reference image by introducing at least one reference feature into the at least one first primary image,
process the least one first reference image with the aid of the at least one algorithm to be checked,
extract at least one test feature associated with the at least one reference feature from the processed at least one first reference image,
compare the at least one test feature with the at least one reference feature and use the result of the comparison to determine the presence of at least one error.

Thanks to the error detection device according to the invention it is possible to reliably identify a multiplicity of errors using little processing power.

Here, it may be advantageous in particular if the at least one reference feature is characterised by a local colour and/or contrast and/or image sharpness manipulation and/or by a local arrangement of pixels.

It is advantageous here are if the at least one computing unit is configured to check the at least one first primary image for the presence of relevant image features and to insert the at least one reference feature into at least one region of the at least one first primary image, in which region there are no relevant image features present.

In order to additionally increase the accuracy of the error detection, the at least one computing unit may be configured to introduce at least two, preferably more reference features into the at least one first primary image and to extract in each case a test feature belonging to each reference feature.

In a favourable variant of the error detection device according to the invention, the at least one computing unit is configured to capture at least one second primary image, wherein at least one second reference image can be produced with the aid of the second primary image, wherein the at least one test feature can be extracted from the at least two reference images. The two primary images may be captured for example at the same time by means of two sensors, whereby depth information can be obtained very quickly by comparison of the two primary images. The test feature may contain depth information in the same manner.

In accordance with a development of the error detection device according to the invention, the at least one reference feature and/or the at least one test feature may relate to at least one object, wherein location information relating to the at least one reference feature and/or the at least one test feature can be extracted. Simple objects, such as triangles, squares or polygons can be used as reference feature/test feature. The selection of the reference features is substantially dependent on the detection algorithms. For conventional “corner detectors”, single-coloured, for example white squares would be suitable for example, which accordingly would generate 4 corners. In order to remove these from the rest of the image, these squares could be surrounded by a dark zone, which becomes increasingly translucent outwardly (i.e. transitions continuously into the original image).

In a favourable embodiment of the error detection device according to the invention, the error detection device has at least one first sensor for recording the at least one first primary image.

In a further advantageous embodiment of the error detection device according to the invention, at least the first primary image and also the second primary image, at a subsequent moment in time or time interval, can be recorded with the aid of the first sensor. The use of a single sensor provides the advantage that this variant can be performed economically and at the same time in a robust manner. The time periods between the recording of the first and the second primary image may be, by way of example, between 0 and 10 ms, 10 and 50 ms, 50 and 100 ms, 100 and 1000 ms or 0 and is or more. Information concerning the movement and spatial position of the individual features can be obtained from a chronological series of relevant features belonging to the primary images (and/or secondary images). This technique has been known by the expression “Structure from Motion” and can be used advantageously in conjunction with the invention.

Alternatively, it may be that at least the first primary image can be recorded with the aid of a first sensor and at least the second primary image can be recorded with the aid of a second sensor. It is thus possible simultaneously to record images from different perspectives by means of the two sensors and to generate depth information by means of a comparison of the images. A simultaneous recording from different perspectives provides the advantage of making the depth information accessible particularly quickly, since there is no need to wait for a chronological series of the images. In addition, a relative movement of the surroundings in relation to the sensors is not necessary. This technology is known by the term “Stereo 3D” and can be used advantageously in conjunction with the invention.

An additional possibility for detecting errors is provided in a further-developed embodiment of the error detection device according to the invention, in which the at least one computing unit captures the at least one first primary image on the basis of a primary image source,
wherein at least one first secondary image can be produced or captured by displacing and/or rotating the at least one first primary image and/or the at least one first reference image,
wherein the at least one first secondary image can be processed with the aid of the algorithm to be checked, and
the at least one first processed primary image and/or the at least one first processed reference image can be compared with the at least one first processed secondary image, and the result of the comparison can be used additionally in order to determine the presence of at least one error.

Here, in accordance with a preferred embodiment, at least one primary image feature can be extracted from the at least one first primary image and/or from the at least one first reference image, and
at least one secondary image feature can be extracted from the at least one first secondary image, and
the at least one primary image feature can be compared with the at least one secondary image feature.

In an advantageous embodiment of the error detection device according to the invention, the at least one computing unit may calculate the at least one primary image feature by local colour information and/or a local contrast and/or a local image sharpness and/or local gradients in at least the first primary image, and/or may calculate the at least one secondary image feature by local colour information and/or a local contrast and/or a local image sharpness and/or local gradients in at least the first secondary image. This allows a quick and reliable detection of relevant image features. Object boundaries or object edges or corners constitute an example of such relevant primary image and/or secondary image features.

In accordance with a development of the error detection device according to the invention, the at least one computing unit can be configured to capture the at least one second primary image and to use this at least one second primary image for the extraction of the at least one primary image feature, wherein at least the first and the second primary image can be displaced and/or rotated and at least the first secondary image and/or an additional second secondary image can be produced under consideration of the second primary image, and the at least one secondary image feature can be extracted from the first secondary image and/or the second secondary image. By using a second primary image, primary image features/secondary image features containing, for example, depth information can be obtained by combining the two primary images or secondary images.

Here, in accordance with a development of the error detection device according to the invention, the at least one first primary image can be rotatable about a vertical axis located in the centre of the image. A sensor mounted on a vehicle can therefore be displaced either together with the vehicle or also individually relative to the surroundings captured by the first sensor. This allows an error detection also when the vehicle is at a standstill or more generally when the vehicle surroundings are not moving relative to the vehicle.

In a favourable embodiment of the error detection device according to the invention the at least one first sensor is displaceable and/or rotatable. By way of example, the at least one first primary image can thus be easily displaced and/or rotated. A sensor mounted on a vehicle can therefore be displaced either together with the vehicle or also individually relative to the surroundings captured by the first sensor. This allows an error detection also when the vehicle is at a standstill or more generally when the vehicle surroundings are not moving relative to the vehicle.

Alternatively, the at least one computing unit can be configured to displace and/or rotate the at least one first primary image digitally. Here as well, a relative displacement between the vehicle and the vehicle surroundings does not have to be provided, for example.

The invention together with further embodiments and advantages will be explained in greater detail hereinafter on the basis of an exemplary non-limiting embodiment illustrated in the figures, in which

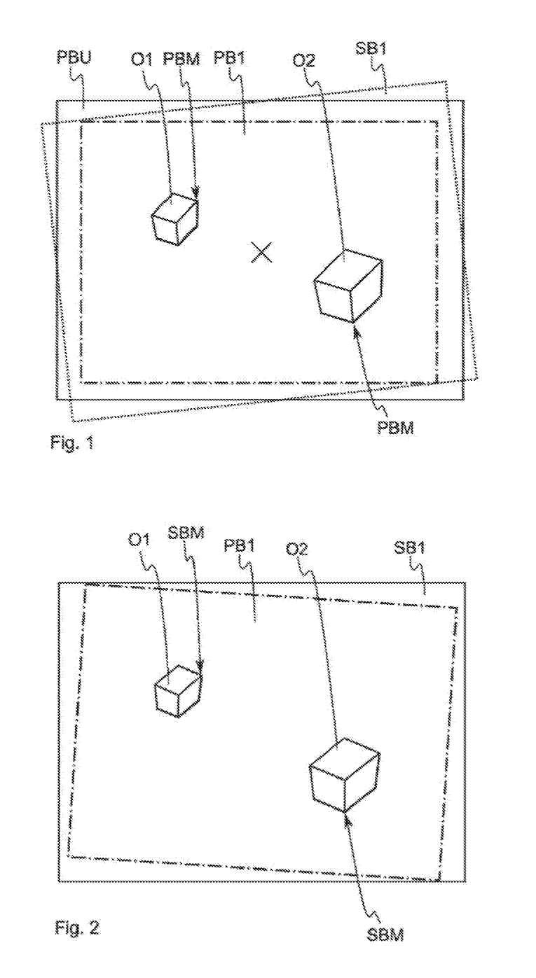

FIG. 1 shows an illustration of a first primary image in a primary image source,

FIG. 2 shows an illustration of a first secondary image corresponding to the first primary image,

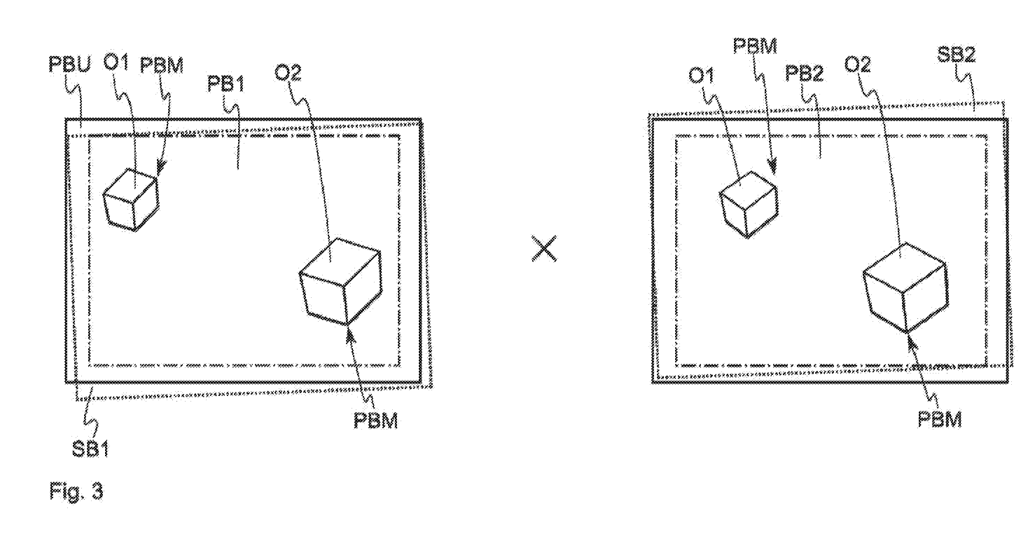

FIG. 3 shows an illustration of a first and a second primary image,

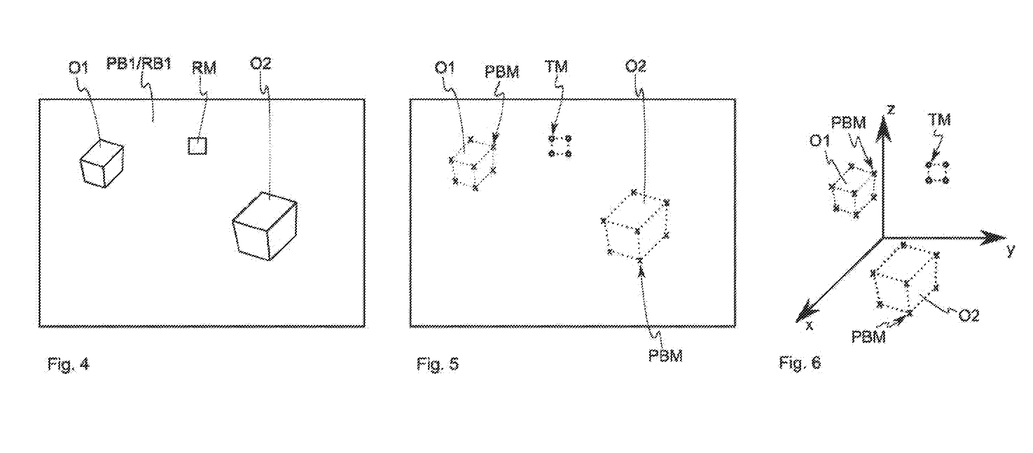

FIG. 4 shows an illustration of a reference image,

FIG. 5 shows an illustration of the processed reference image,

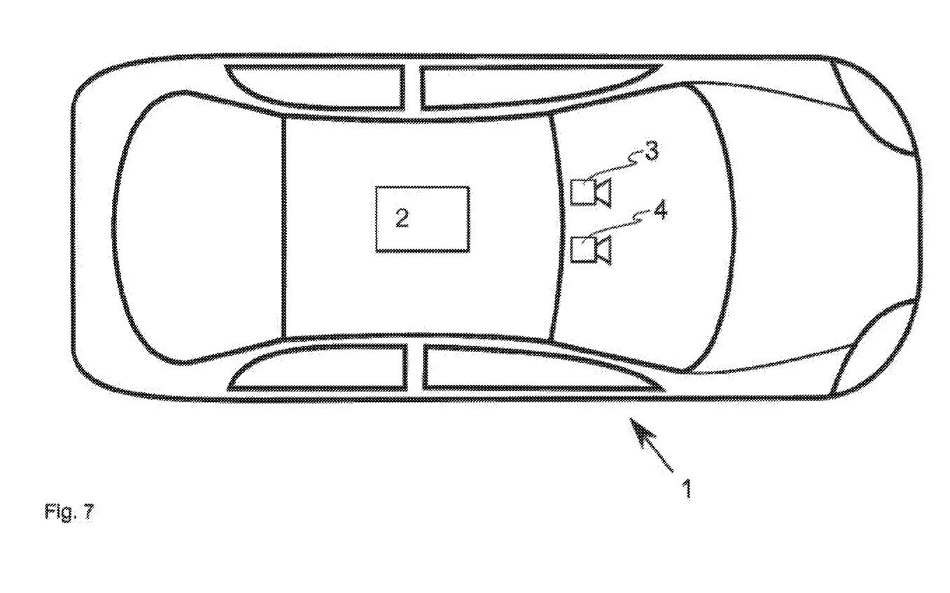

FIG. 6 shows an illustration of the allocation of image features to space coordinates, and

FIG. 7 shows a plan view of a vehicle having an error detection device according to the invention.

FIG. 1 shows an illustration of a first primary image PB1, which is arranged by way of example in the centre of a primary image source PBU. The first primary image PB1 here forms a subset of the primary image source PBU, which extends beyond the first primary image PB1, wherein the first primary image PB1 is delimited by a dot-and-dash line. For example, two cuboidal objects P1 and O2 can be seen in the first primary image PB1 and are suitable for the detection of primary image features PBM. By way of example, primary image features associated with the respective objects O1 and O2 have been provided in each case with a reference sign PBM, wherein these primary image features PBM are located at a corner of the objects O1 and O2. A multiplicity of primary image features PBM, for example a plurality of the corners, in particular each visible corner detected in the image, are usually captured in order to enable a particularly reliable detection of objects. In principle, all image features which, even after a manipulation or minor change of the primary images, can be reliably detected again are suitable as primary image features. This is dependent in particular on the type of manipulation or the change to the images. Further features that may be suitable as primary image feature include, for example, object edges, local colour information, a local contrast, a local image sharpness and/or local gradients in the first primary image PB1. The image features therefore do not necessarily have to be associated with an object, but can be formed in essence by any detectable features (the same is true analogously for the primary image features PBM of a second primary image PB2 described hereinafter and also further optional primary images, secondary image features SBM of secondary images, in particular of a first and second secondary image SB1 and SB2, and also further optional secondary images).

A central point of FIG. 1 or of the primary image PB1 is characterised by a cross X, which represents the point of intersection of a vertical axis of rotation with an image plane associated with the first primary image PB1 (the term “vertical axis of rotation” is understood within the scope of this application to mean that the axis of rotation is oriented normal to the image plane). In accordance with one aspect of the invention a comparison of image features of a primary image with the image features of a subsequent image (what is known as a secondary image) produced by displacing and/or rotating the primary image can be used to determine errors in the image processing system, in particular in the under-lying algorithms. FIG. 1 shows an exemplary first secondary image SB1, in which the primary image source PBU and therefore the first primary image PB1 has been rotated about the vertical axis of rotation, illustrated by the cross, through approximately 15° in an anti-clockwise direction. The rotation (or also a displacement) can be performed arbitrarily in principle, and it is merely important that the secondary image, here the first secondary image SB1, has a sufficient number of corresponding image features (corresponding to the associated primary image), these being known as secondary image features SBM (see FIG. 2).

The first secondary image SB1 corresponding to the first primary image PB1 is now presented with reference to FIG. 2 (unless specified otherwise, the same features are designated by the same reference signs within the scope of this application). In this shown example the first primary image PB1 is captured completely by the first secondary image SB1, wherein the objects O1 and O2 have been rotated accordingly together with the primary image source PBU. This rotation can be achieved as mentioned in the introduction on the one hand by a digital image processing, and on the other hand one or more sensors capturing the images (primary images, secondary images) could also be rotated and/or displaced accordingly. In particular, image capture sensors mounted on a vehicle can be used in order to provide the images to be processed. Here, a rotation and/or in particular a displacement, in particular a horizontal displacement of the secondary images, can also be achieved in a simple manner by means of a movement of the vehicle relative to its surroundings (as is typically provided during a journey of the vehicle). Exemplary image features of the objects O1 and O2 are designated therein as secondary image features SBM.

In accordance with a further aspect of the invention a number of primary images or associated secondary images can be used in order to be checked with the aid of the method according to the invention. FIG. 3 thus shows an illustration of two primary images, specifically of the first primary image PB1 and of a second primary image PB2, wherein the second primary image PB2 provides a different perspective of the image content of the first primary image PB1. This can be achieved for example by a spatial offset of two sensors mounted on a vehicle (known under the term “Stereo 3D”). Alternatively, it is also possible to provide a modified perspective by means of a temporal offset of the recording of the primary images (known by the term “structure from motion”).

The illustration of the objects O1 and O2 from at least two different perspectives allows the extraction of depth information belonging to the objects. Objects can therefore be captured three-dimensionally. A rotation of the first and the second primary image PB1 and PB2 (wherein the second primary image PB2 is assigned a second secondary image SB2) is performed here preferably via a vertical axis of rotation arranged centrally between the two images and illustrated in FIG. 3 by a cross. This has the advantage that both images are rotated to the same extent and as many image points as possible of the primary images are retained in the secondary images.

The method according to the invention can be used to check a multiplicity of images calculated by means of image processing or to check the algorithms forming the basis of the processing. The check can be performed here image for image, wherein for example a recorded image following a secondary image (said recorded image being referred to as a following image) can be compared with the secondary image (in particular with the image features). In this case the original secondary image forms the primary image in relation to the following image, which would then be used as a secondary image. A sequence of any length of images can thus be checked, wherein successor images (secondary images) or features thereof are compared with precursor images (primary images) or features thereof.

FIG. 4 shows a further aspect of the invention, in accordance with which a reference feature RM is introduced into the first primary image PB1, which is referred to as the first reference image RB1 following the introduction of the reference feature RM. Reference features RM are features introduced artificially into the image and which can be used in the manner described hereinafter to detect errors in image processing systems. Reference features RM can be characterised for example by a local colour, contrast and/or image sharpness manipulation and/or by a local arrangement of pixels. Simple objects, such as triangles, squares or polygons can be used as reference feature/test feature. The selection of the reference features is substantially dependent on the detection algorithms. For conventional “corner detectors”, single-coloured, for example white squares would be suitable for example, which accordingly would produce 4 corners. In order to remove these from the rest of the image, these squares could be surrounded by a dark zone, which becomes increasingly translucent outwardly (i.e. transitions continuously into the original image). In the shown example reference feature is a square, which is lifted from the image background by black solid lines. If the reference features are corners or edges of artificially introduced objects, as is the case in the shown example, these may be mathematically visible for example by folding operations using appropriate filters, for example gradient filters, and can be extracted from the images, which usually can be illustrated in the image processing as a matrix, in which each image point is assigned at least one numerical value, wherein the numerical value represents the colour and/or intensity of an image point. An algorithm to be checked in accordance with step c) of the method according to the invention for example may be an algorithm with the aid of which individual objects in the image can be detected or with the aid of which image features can be extracted (for example the aforementioned filtering by means of a gradient filter).

The reference image RB1 is processed with the aid of an algorithm which can be checked by means of the method according to the invention. FIG. 5 thus shows an illustration of the processed reference image RB1, in which the primary image features PBM belonging to the objects O1 and O2 can be seen. The processed reference feature RM in FIG. 4 is designated therein as test feature TM, which is characterised substantially by four corner points and is extracted from the first reference image RB1 in step d) according to the invention. Since the properties of the reference feature RM can be predefined and the behaviour of the algorithm processing the first reference image RB1 can be adequately predicted, expectation values can be generated in respect of the test feature TM. Values for the expected correlation between the test feature TM and the reference feature RM can be predicted depending on the image-processing algorithm (for example a gradient filter function and a subsequent object detection). A value deviating significantly from the expected correlation can thus be used to detect errors (according to step e) of the invention) in the processing of the images (for example a gradient filter function and a subsequent object detection). By way of example, an absence or disproportionate change of a corresponding test feature TM when a reference feature RM is introduced into the primary image would be a clear indication of the presence of an error, which would be determined in step e). The error may have occurred for example as a result of an error with the data processing (hardware and/or software) or with the image processing, for example with the extraction of the image features. These may be caused in principle by hardware defects, overfilled memories, bit errors, programming errors, etc.

In the shown example reference feature RM has been introduced into a primary image. Alternatively or additionally, a reference feature RM can also be introduced into a secondary image. Two or more reference features can also be provided in order to additionally increase the sensitivity of the error detection.

FIG. 6 shows an illustration of the allocation of image features to space coordinates, in particular a Cartesian coordinate system oriented in a right-handed manner. If depth information relating to the image features can be extracted, it is possible to detect these image features three-dimensionally and also to check said features.

FIG. 7 shows a plan view of a vehicle 1 having an error detection device according to the invention in a preferred embodiment. The error detection device consists in this case of a computing unit 2 and a first sensor 3 and also a second sensor 4, which are each arranged in a front region of the vehicle 1. The sensors 3 and 4 transmit the captured image data to the computing unit 2 (for example in a wired manner or by radio), wherein the computing unit 2 processes these images and checks the processing of the images with the aid of the method according to the invention outlined in the introduction. The image data can be present in any format suitable for the calculation and/or display thereof. Examples of this include the raw, jpeg, bmp, or png format and also conventional video formats. The computing unit 2 is located in the shown example in the vehicle 1 and can switch the vehicle 1 into a safe state following detection of an error. Should an object which has been detected by the computing unit 2 suddenly no longer be captured by the computing unit 2 on account of an error of the image processing, a stopping of the vehicle for example can be initiated in order to prevent a collision with the previously detected object. The computing unit 2 can initiate a multiplicity of further measures or can perform functions that increase the safety and/or the reliability of image processing algorithms, which may be of particular importance in particular in vehicle applications. The computing unit 2 does not have to be centrally constructed, but may also consist of two or more computing modules.

Since the invention disclosed within the scope of this description can be used in a versatile manner, not all possible fields of application can be described in detail. Rather, a person skilled in the art, under consideration of these embodiments, is able to use and adapt the invention for a wide range of different purposes.

1. A method for error detection for at least one image processing system for capturing the surroundings of a motor vehicle, the method comprising:
a) capturing at least one first primary image (PB1);
b) producing at least one first reference image (RB1) by introducing at least one reference feature (RM) into the at least one first primary image (PB1);
c) processing the at least one first reference image (RB1) with the aid of at least one algorithm to be checked;
d) extracting at least one test feature (TM) associated with the at least one reference feature (RM) from the processed at least one first reference image (RB1); and
e) comparing the at least one test feature (TM) with the at least one reference feature (RM) and using the result of the comparison in order to determine the presence of at least one error.

2. The method of claim 1 wherein the at least one reference feature (RM) is characterised by a local colour, contrast and/or image sharpness manipulation and/or by a local arrangement of pixels.

3. The method of claim 1, wherein before step b) the at least one first primary image (PB1) is checked for the presence of relevant image features, and in step b) the at least one reference feature (RM) is inserted into at least one region of the at least one first primary image (PB1), in which region there are no relevant image features present.

4. The method of claim 1, wherein in step b) at least two reference features (RM) are introduced into the at least one first primary image (PB1), and wherein in step d) a test feature (TM) is extracted for each reference feature (RM).

5. The method of claim 1, wherein in step a) at least one second primary image (PB2) is captured, wherein in step b) at least one second reference image (RB2) is produced with the aid of the second primary image (PB2), and wherein in step c) the at least one test feature (TM) is extracted from the at least two reference images (RB1, RB2).

6. The method of claim 1, wherein the at least one reference feature (RM) and/or the at least one test feature (TM) relates to at least one object (O1, O2), and wherein location information relating to the at least one reference feature (RM) and/or the at least one test feature (TM) is extracted.

7. The method of claim 5, wherein the at least one first primary image (PB1) is recorded with the aid of at least one first sensor (3).

8. The method of claim 5, wherein at least the first and the second primary images (PB1, PB2) are recorded with the aid of a first sensor (3), and wherein the second primary image (PB2) is recorded once the first primary image (PB1) has been recorded.

9. The method of claim 3, wherein at least the first primary image (PB1) is recorded with the aid of a first sensor (3) and at least the second primary image (PB2) is recorded with the aid of a second sensor (4).

10. The method of claim 1, wherein in step a) the at least one first primary image (PB1) is captured on the basis of a primary image source (PBU), and the method further comprises:
f) producing or capturing, after step a), at least one first secondary image (SB1) by displacing and/or rotating the at least one first primary image (PB1) and/or the at least one first reference image (RB1);
g) processing, after step f), the at least one first secondary image (SB1) with the aid of the algorithm to be checked; and
h) comparing, after step g,), the at least one first processed primary image (PB1) and/or the at least one first processed reference image (RB1) with the at least one first processed secondary image (SB1), in order to determine the presence of at least one error.

11. The method of claim 10, wherein:
after step a) at least one primary image feature (PBM) is extracted from the at least one first primary image (PB1) and/or from the at least one first reference image (RB1),
after step f) at least one secondary image feature (SBM) is extracted from the at least one first secondary image (SB1), and
in step h) the at least one primary image feature (PBM) is compared with the at least one secondary image feature (SBM).

12. The method of claim 11, wherein the at least one primary image feature (PBM) is calculated by local colour information, a local contrast, a local image sharpness and/or local gradients in at least the first primary image (PB1), and/or the at least one secondary image feature (SBM) is calculated by local colour information, a local contrast, a local image sharpness and/or local gradients in at least the first secondary image (SB1).

13. The method of claim 11, wherein:
at least one second primary image (PB2) is captured in step a) and used for extraction of the at least one primary image feature (PBM),
in step f) at least the first and the second primary images (PB1) and (PB2) are displaced and/or rotated and at least the first secondary image (SB1) and/or an additional second secondary image (SB2) is produced under consideration of the second primary image (PB2), and
after step f) the at least one secondary image feature SBM) is extracted from the first secondary image (SB1) and/or the second secondary image (SB2).

14. The method of claim 11, wherein the at least one primary image feature (PBM) and/or the at least one secondary image feature (SBM) relates to at least one object (O1, O2), and wherein location information is extracted for the at least one primary image feature (PBM) and/or the at least one secondary image feature (SBM).

15. The method of claim 11, wherein the at least one first primary image (PB1) is rotated in step f) about a vertical axis located in the centre of the image.

16. The method of claim 11, wherein the displacement and/or rotation of the at least one first primary image (PB1) in step f) is achieved at least by a physical displacement and/or rotation of the position and/or the orientation of at least one first sensor (3).

17. The method of claim 15, wherein the displacement and/or rotation of the at least one first primary image (PB1) in step f) is achieved at least by a digital processing of the at least one first primary image (PB1).

18. An error detection device for at least one image processing system for capturing the surroundings of a motor vehicle, the device comprising:
at least one computing unit (2) which is configured to
capture at least one first primary image (PB1),
produce at least one first reference image (RB1) by introducing at least one reference feature (RM) into the at least one first primary image (PB1),
process the at least one first reference image (RB1) with the aid of at least one algorithm to be checked,
extract at least one test feature (TM) associated with the at least one reference feature (RM) from the processed at least one first reference image (RB1), and
compare the at least one test feature (TM) with the at least one reference feature (RM) and use the result of the comparison in order to determine the presence of at least one error.

19. The error detection device of claim 18, wherein the at least one reference feature (RM) is characterised by a local colour, contrast and/or image sharpness manipulation and/or by a local arrangement of pixels.

20. The error detection device of claim 18, wherein the at least one computing unit (2) is configured to check the at least one first primary image (PB1) for the presence of relevant image features and to insert the at least one reference feature (RM) into at least one region of the at least one first primary image (PB1), in which region there are no relevant image features present.

21. The error detection device of claim 18, wherein the at least one computing unit (2) is configured to introduce at least two reference features (RM) into the at least one first primary image (PB1) and to extract in each case a test feature (TM) belonging to each reference feature (RM).

22. The error detection device of claim 18, wherein the at least one computing unit (2) is configured to capture at least one second primary image (PB2), wherein at least one second reference image (RB2) can be produced with the aid of the second primary image (PB2), and wherein the at least one test feature (TM) can be extracted from the at least two reference images (RB1, RB2).

23. The error detection device of claim 18, wherein the at least one reference feature (RM) and/or the at least one test feature (TM) relates to at least one object (O1, O2), and wherein location information relating to the at least one reference feature (RM) and/or the at least one test feature (TM) can be extracted.

24. The error detection device of claim 22, further comprising at least one first sensor (3) for recording the at least one first primary image (PB1).

25. The error detection device of claim 22, wherein at least the first primary image (PB1) and the second primary image (PB2), at a subsequent moment in time or time interval, can be recorded with the aid of a first sensor (3).

26. The error detection device of claim 20, wherein at least the first primary image (PB1) can be recorded with the aid of a first sensor (3) and at least the second primary image (PB2) can be recorded with the aid of a second sensor (4).

27. The error detection device of claim 18, wherein:
the at least one computing unit (2) captures the at least one first primary image (PB1) on the basis of a primary image source (PBU),
at least one first secondary image (SB1) can be produced or captured by displacing and/or rotating the at least one first primary image (PB1) and/or the at least one first reference image (RB1),
the at least one first secondary image (SB1) can be processed with the aid of the algorithm to be checked, and
the at least one first processed primary image (PB1) and/or the at least one first processed reference image (RB1) can be compared with the at least one first processed secondary image (SB1) and the result of the comparison can be used additionally in order to determine the presence of at least one error.

28. The error detection device of claim 27, wherein:
at least one primary image feature (PBM) can be extracted from the at least one first primary image (PB1) and/or from the at least one first reference image (RB1),
at least one secondary image feature (SBM) can be extracted from the at least one first secondary image (SB1), and
the at least one primary image feature (PBM) can be compared with the at least one secondary image feature (SBM).

29. The error detection device of claim 28, wherein the at least one computing unit (2) calculates the at least one primary image feature (PBM) by local colour information, a local contrast, a local image sharpness and/or local gradients in at least the first primary image (PB1), and/or calculates the at least one secondary image feature (SBM) by local colour information, a local contrast, a local image sharpness and/or local gradients in at least the first secondary image (SB1).

30. The error detection device of claim 28, wherein the at least one computing unit (2) is configured to capture the at least one second primary image (PB2) and to use this at least one second primary image for the extraction of the at least one primary image feature (PBM), wherein at least the first and the second primary images (PB1, PB2) can be displaced and/or rotated and at least the first secondary image (SB1) and/or an additional second secondary image (SB2) can be produced under consideration of the second primary image (PB2), and the at least one secondary image feature (RBM) can be extracted from the first secondary image (SB1) and/or the second secondary image (SB2).

31. The error detection device of claim 27, wherein the at least one first primary image (PB1) is rotatable about a vertical axis located in the centre of the image.

32. The error detection device of claim 27, further comprising at least one first sensor (3) that is displaceable and/or rotatable.

33. The error detection of claim 31, wherein the at least one computing unit (2) is configured to displace and/or rotate the at least one first primary image (PB1) digitally.
